(19) United States
(12) Patent Application Publication
(10) Pub. No.: US 2026/0334386 A1
(43) Pub. Date: Oct. 29, 2026

(54) ATMOSPHERIC AEROSOL CONTROL

(71) Applicant: International Business Machines Corporation, Armonk, NY (US)

(72) Inventors: Manikandan PADMANABAN, Chennai (IN); Jagabondhu HAZRA, Bangalore (IN); Sarbajit Kumar RAKSHIT, Kolkata (IN); Sumedha BHATIA, New Delhi (IN)

(21) Appl. No.: 19/192,807

(22) Filed: Apr. 29, 2025

(51) Int. Cl. A01G 15/00; G06Q 10/0631; G06Q 50/02

(52) U.S. Cl. CPC A01G 15/00; G06Q 10/06315; G06Q 50/02

(57) ABSTRACT

In some implementations, a computer system receives a satellite observation and a geo-spatial model of a forest or agricultural ecosystem. The computer system estimates, based on the satellite observation and the geo-spatial model, a forecasted spatiotemporal distribution of aerosol concentration and a corresponding aerosol impact on photosynthesis activity in the forest or agricultural ecosystem. The computer system determines, from the satellite observation, a dust profile and a corresponding dust impact on the photosynthesis activity based on spectral reflectance from leaves in the forest or agricultural ecosystem. The computer system estimates an amount of cloud seeding or an amount of aerosol ionization to maintain an optimal aerosol optical depth in an atmosphere above the forest or agricultural system. The computer system determines an optimal set of locations for the cloud seeding or the aerosol ionization based on a cost-benefit analysis. The computer system outputs the optimal set of locations.

### BACKGROUND

This disclosure generally relates to atmospheric analysis and, more specifically, to determining an optimal aerosol optical depth for atmospheric carbon sequestration.

### SUMMARY

Some aspects described herein relate to a method. The method may include receiving a satellite observation and a geo-spatial model of a forest or agricultural ecosystem. The method may include estimating, based on the satellite observation and the geo-spatial model, a forecasted spatiotemporal distribution of aerosol concentration and a corresponding aerosol impact on photosynthesis activity in the forest or agricultural ecosystem. The method may include determining, from the satellite observation, a dust profile and a corresponding dust impact on the photosynthesis activity based on spectral reflectance from leaves in the forest or agricultural ecosystem. The method may include estimating an amount of cloud seeding or an amount of aerosol ionization to maintain an optimal aerosol optical depth in an atmosphere above the forest or agricultural system. The method may include determining an optimal set of locations for the cloud seeding or the aerosol ionization based on a cost-benefit analysis. The method may include outputting the optimal set of locations.

Some aspects described herein relate to a computer system. The computer system may include a processor set, one or more computer-readable storage media, and program instructions stored on the one or more computer-readable storage media to cause the processor set to perform operations. The operations may include receiving a satellite observation and a geo-spatial model associated with a forecasted spatiotemporal distribution of aerosol concentration and an impact on photosynthesis activity in a forest or an agricultural ecosystem. The operations may include determining a forecasted dust profile on leaves and a corresponding impact on the photosynthesis activity of the forest or the agricultural ecosystem using spectral reflectance from the leaves. The operations may include outputting, based on a cost-benefit analysis, an indication of whether to perform cloud seeding or aerosol ionization to maintain an optimal aerosol optical depth in an atmosphere above the forest or the agricultural ecosystems.

Some aspects described herein relate to a computer program product. The computer program product may include one or more computer-readable storage media and program instructions stored on the one or more computer-readable storage media to perform operations. The operations may include evaluating, a satellite observation and a geo-spatial model, a forecasted spatiotemporal distribution of aerosol concentration above a forest or agricultural ecosystem and a corresponding impact on photosynthesis activity in the forest or agricultural ecosystem. The operations may include estimating an amount of cloud seeding or an amount of aerosol ionization to maintain an optimal aerosol optical depth in an atmosphere above the forest or agricultural ecosystem based on a volumetric analysis. The operations may include outputting an indication to deploy cloud seeding or aerosol ionization to maximize the photosynthesis activity or carbon sequestration based on a cost-benefit analysis.

### BRIEF DESCRIPTION OF THE DRAWINGS

FIG. 1 is a diagram of an example computing environment for controlling atmospheric aerosol as described herein.

FIG. 2 illustrates an example of direct and diffuse sunlight that radiates on the Earth's surface and aerosols that can affect this radiation.

FIG. 3 is a diagram of an example of cloud seeding.

FIG. 4A is a diagram of an example implementation associated with controlling aerosol in the atmosphere.

FIG. 4B illustrates components of the computer system, such as the aerosol control code of FIG. 1 that may perform operations of a computer-implemented method shown in FIG. 4A.

FIG. 5 is an example of a spatial map.

FIG. 6 is a flowchart of an example process associated with atmospheric aerosol control.

FIG. 7 is a flowchart of an example process associated with atmospheric aerosol control.

FIG. 8 is a flowchart of an example process associated with atmospheric aerosol control.

### DETAILED DESCRIPTION

The following detailed description of example implementations refers to the accompanying drawings. The same reference numbers in different drawings may identify the same or similar elements.

Natural photosynthesis by plant leaves reduces the carbon in the atmosphere. However, aerosols in the atmosphere can significantly impact this photosynthesis by altering the amount and type of sunlight radiation that reaches the plant leaves. Aerosols can decrease the amount of direct radiation available for photosynthesis, while increasing the amount of diffuse radiation. This can have opposing effects on photosynthesis, depending on the type of leaves and the environmental conditions.

Maintaining an optimal aerosol optical depth (AOD) in the atmosphere is necessary to maximize photosynthesis activity and carbon sequestration. However, determining the optimal AOD is complex due to the varying sensitivities of different leaf types to changes in light, air temperature, and humidity. Current methods for estimating aerosol concentrations and their impact on photosynthesis are limited, and there is a need for a more accurate and comprehensive approach that takes into account the complex interactions between aerosols, radiation, and plant leaves.

Some implementations provide a computer system that performs a method for accelerating natural carbon sequestration by optimizing AOD in the atmosphere above a forest or agricultural ecosystem to maximize photosynthesis activity. For example, the computer system may receive satellite observations and geo-spatial models of the ecosystem and estimate the forecasted spatiotemporal distribution of aerosol concentration and its impact on photosynthesis activity. “Geo-spatial model” refers to a mathematical or computational representation of a geographical area, incorporating various types of data, such as spatial, temporal, and thematic information, to analyze, simulate, and predict the behavior of complex systems and phenomena in that area. These models use geographic information systems (GISs), remote sensing, and other spatial analysis techniques to create detailed, layered representations of the environment. In some implementations, the geo-spatial model represents a forest or agricultural ecosystem, incorporating data such as topography (elevation, slope, aspect) and land use/land cover (vegetation types, soil types). By integrating these diverse data sets, a geo-spatial model can help estimate the forecasted spatiotemporal distribution of aerosol concentration and its impact on photosynthesis activity in the forest or agricultural ecosystem, as mentioned above. “Spatiotemporal distribution of aerosol concentration” refers to the three-dimensional representation of the concentration of aerosols (tiny particles suspended in the air) in a specific geographic area over a period of time. The spatial aspect of the spatiotemporal distribution may include the concentration of aerosols (e.g., micrograms per cubic meter or parts-per-billion) at different locations (latitude, longitude), altitudes or heights (e.g., near the ground, at different levels of the atmosphere), distances from emission sources, or other relevant features. “Temporal aspect” may refer to the distribution of aerosols over time, including changes in concentration and patterns.

The computer system may also determine the dust profile of the forest or agricultural ecosystem and its impact on photosynthesis activity based on spectral reflectance from leaves. A dust profile, in the context of plant leaves, refers to the type, amount, and distribution of dust particles on the surface of the leaves. Dust can settle on leaves due to various natural and anthropogenic sources, such as soil erosion, urbanization, and industrial activities. The dust profile on leaves may be characterized by the type of dust. There may be different types of dust, such as mineral dust, soil dust, or industrial dust, which can have varying effects on leaves. The dust profile may include an amount of dust. The amount of dust on the leaves can impact photosynthesis, with higher amounts potentially reducing photosynthetic activity. The dust profile may include a distribution of dust, or the way in which dust is distributed on the leaves, such as evenly or unevenly, as the distribution can also affect photosynthesis.

The impact of dust on photosynthesis activity can be assessed using spectral reflectance from leaves. Spectral reflectance is a measure of the amount of light reflected by an object at different wavelengths. By analyzing the spectral reflectance from leaves, the presence and characteristics of dust on the leaf surface may be inferred. The effects of dust on photosynthesis may include reduced light absorption, increased reflectance (dust can increase the reflectance of light from the leaf surface, reducing the amount of light absorbed by the leaf), altered leaf temperature (dust can alter the leaf temperature, which can affect photosynthetic rates), and reduced stomatal conductance (limiting the exchange of carbon dioxide and water vapor between the leaf and the atmosphere). Several spectral reflectance indices can be used to characterize the dust profile and its impact on photosynthesis. Normalized difference vegetation index (NDVI) is a widely used index that relates reflectance in the near-infrared and red parts of the spectrum to vegetation health and biomass. Enhanced vegetation index (EVI) is a modified version of NDVI that takes into account the impact of atmospheric aerosols on reflectance, soil-adjusted vegetation index (SAVI), and dust-related indices (e.g., dust aerosol index (DAI)). By analyzing the spectral reflectance from leaves and applying these indices, the dust profile and its impact on photosynthesis activity may be estimated, which can inform strategies for optimizing agricultural and forestry practices, as well as monitoring and mitigating the effects of environmental pollution.

The computer system may also estimate the amount of cloud seeding or aerosol ionization required to maintain an optimal AOD. The computer system may determine the optimal set of locations for cloud seeding or aerosol ionization based on a cost-benefit analysis and output the optimal set of locations (e.g., transmit a message, provide to a user display). In this way, the system optimizes aerosol concentrations and maximizes photosynthesis activity by reducing computational resource requirements associated with modeling complex interactions between aerosols, radiation, and plant leaves. Furthermore, the system conserves processing resources, memory resources, network resources, and/or the like by streamlining the analysis of satellite observations and geo-spatial models, thereby reducing the computational complexity associated with determining optimal AOD levels. Additionally, the system may also reduce energy resources required for cloud seeding and aerosol ionization by identifying the optimal set of locations for deployment, thereby minimizing resource consumption while maximizing the gain in photosynthesis activity or carbon sequestration.

In some aspects, the computer system may perform a cost-benefit analysis. The computer system may evaluate the trade-off between the gain in photosynthesis activity or carbon sequestration and the cost incurred in deploying cloud seeding or aerosol ionization, and estimate the cost of additional photosynthesis activity or carbon sequestration after clearing aerosol and dust in the leaves. The computer system may also estimate the cost of cloud seeding and aerosol ionization.

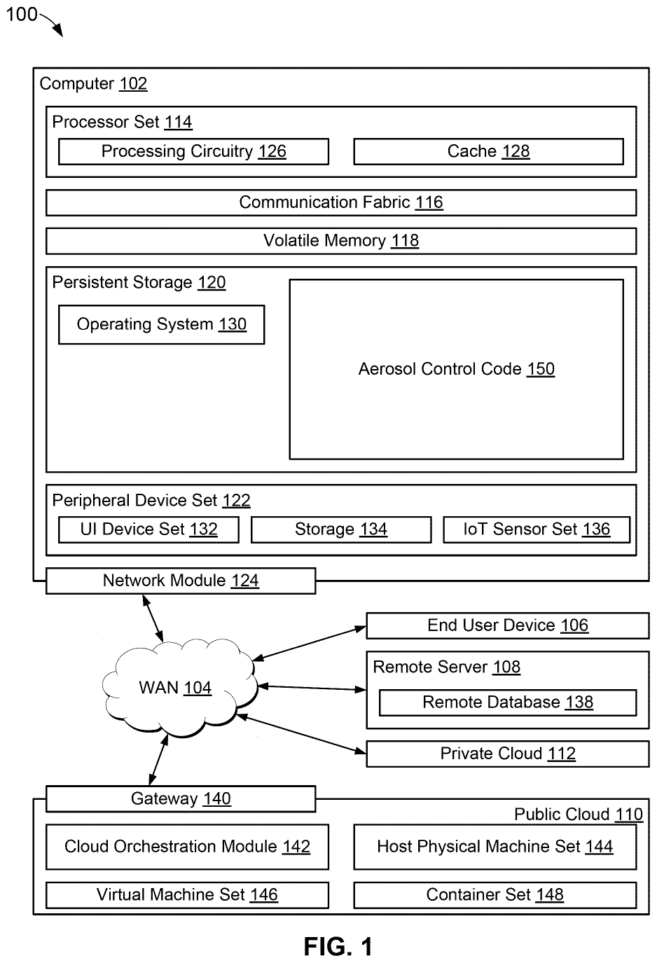

FIG. 1 is a diagram of an example computing environment 100 for controlling atmospheric aerosol as described herein.

Computing environment 100 contains an example of an environment for the execution of at least some of the computer code involved in performing the inventive methods, such as aerosol control code 150. In addition to aerosol control code 150, computing environment 100 includes, for example, computer 102, wide area network (WAN) 104, end user device (EUD) 106, remote server 108, public cloud 110, and private cloud 112. In this embodiment, computer 102 includes processor set 114 (including processing circuitry 126 and cache 128), communication fabric 116, volatile memory 118, persistent storage 120 (including operating system 130 and aerosol control code 150, as identified above), peripheral device set 122 (including user interface (UI) device set 132, storage 134, and Internet of Things (IoT) sensor set 136), and network module 124. Remote server 108 includes remote database 138. Public cloud 110 includes gateway 140, cloud orchestration module 142, host physical machine set 144, virtual machine set 146, and container set 148.

Computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 138. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 102, to keep the presentation as simple as possible. Computer 102 may be located in a cloud, even though it is not shown in a cloud in FIG. 1. On the other hand, computer 102 is not required to be in a cloud except to any extent as may be affirmatively indicated.

Processor set 114 includes one, or more, computer processors of any type now known or to be developed in the future. Processing circuitry 126 may be distributed over multiple packages (for example, multiple, coordinated integrated circuit chips). Processing circuitry 126 may implement multiple processor threads and/or multiple processor cores. Cache 128 is memory that is located in the processor chip package(s) and is typically used for data or code that should be available for rapid access by the threads or cores running on processor set 114. Cache memories are typically organized into multiple levels depending upon relative proximity to the processing circuitry. Alternatively, some, or all, of the cache for the processor set may be located “off chip.” In some computing environments, processor set 114 may be designed for working with qubits and performing quantum computing.

Computer-readable program instructions are typically loaded onto computer 102 to cause a series of operational steps to be performed by processor set 114 of computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 128 and the other storage media discussed below. The program instructions, and associated data, are accessed by processor set 114 to control and direct performance of the inventive methods. In computing environment 100, at least some of the instructions for performing the inventive methods may be stored in aerosol control code 150 in persistent storage 120.

Communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 118 is any type of volatile memory now known or to be developed in the future. Examples include dynamic type random access memory (RAM) or static type RAM. Typically, volatile memory 118 is characterized by random access, but this is not required unless affirmatively indicated. In computer 102, the volatile memory 118 is located in a single package and is internal to computer 102, but, alternatively or additionally, the volatile memory may be distributed over multiple packages and/or located externally with respect to computer 102.

Persistent storage 120 is any form of non-volatile storage for computers that is now known or to be developed in the future. The non-volatility of this storage means that the stored data is maintained regardless of whether power is being supplied to computer 102 and/or directly to persistent storage 120. Persistent storage 120 may be a read only memory (ROM), but typically at least a portion of the persistent storage allows writing of data, deletion of data, and re-writing of data. Some familiar forms of persistent storage include magnetic disks and solid-state storage devices. Operating system 130 may take any of several forms, such as various known proprietary operating systems or open source Portable Operating System Interface-type operating systems that employ a kernel.

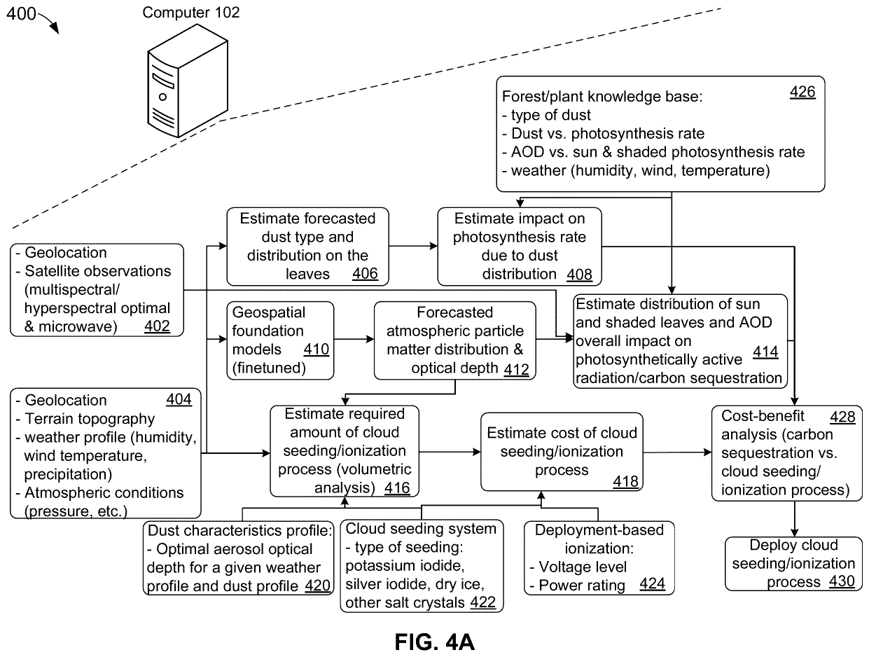

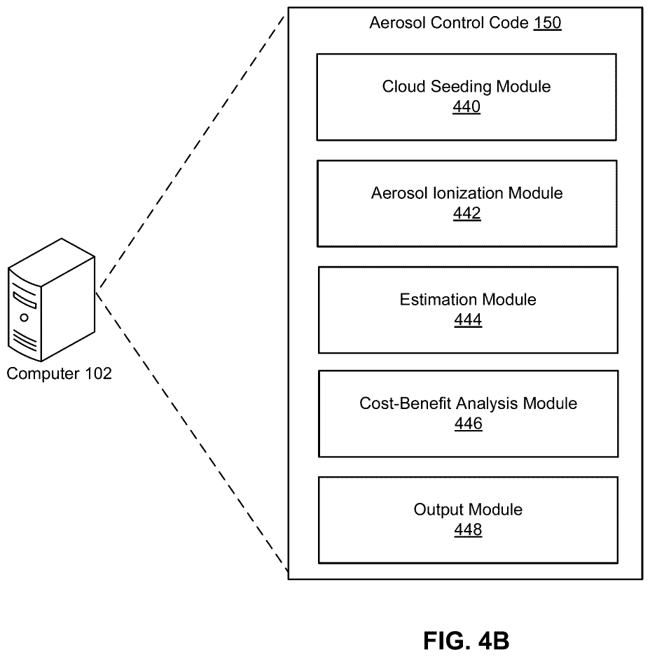

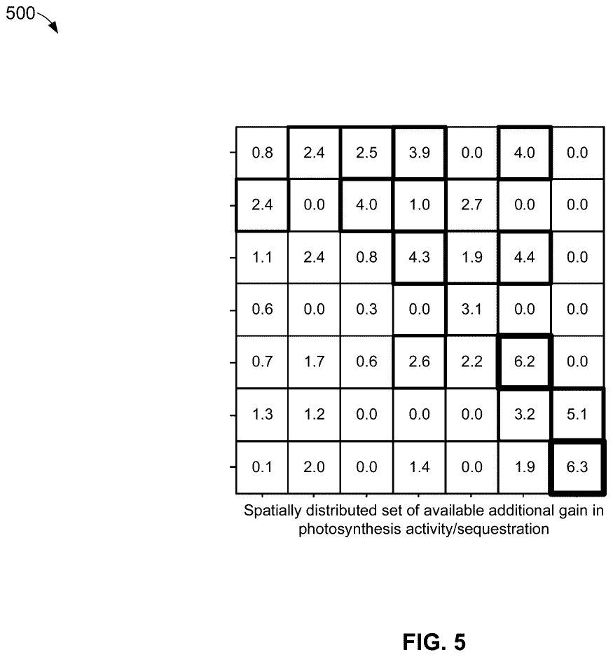

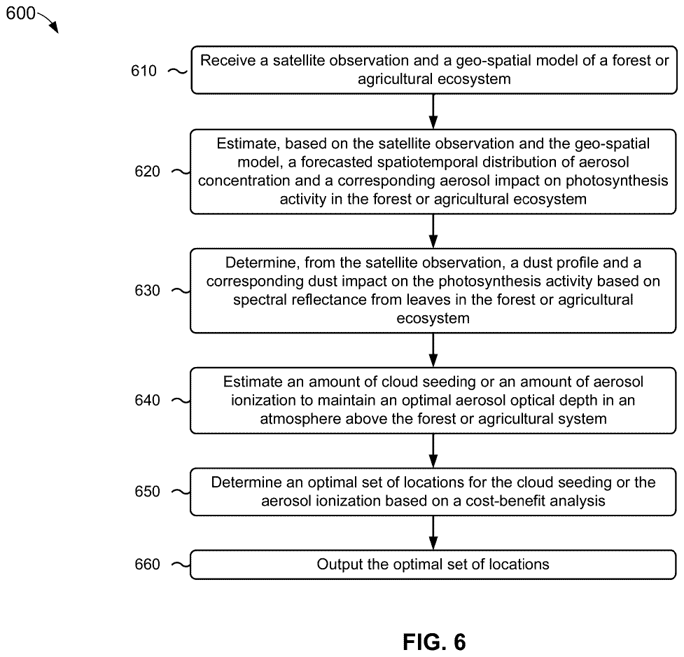

The code included in the aerosol control code 150 typically includes at least some of the computer code involved in performing one or more operations described herein, such as the operations of implementation 400 in FIGS. 4A and 4B, FIG. 5, and the processes described in FIGS. 6-8.

Peripheral device set 122 includes the set of peripheral devices of computer 102. Data communication connections between the peripheral devices and the other components of computer 102 may be implemented in various ways, such as Bluetooth® connections, Near-Field Communication (NFC) connections, connections made by cables (such as universal serial bus (USB) type cables), insertion-type connections (for example, secure digital (SD) card), connections made through local area communication networks and/or connections made through wide area networks such as the internet. In various embodiments, UI device set 132 may include components such as a display screen, speaker, microphone, wearable devices (such as goggles and smart watches), keyboard, mouse, printer, touchpad, game controllers, and/or haptic devices. Storage 134 is external storage, such as an external hard drive, or insertable storage, such as an SD card. Storage 134 may be persistent and/or volatile. In some embodiments, storage 134 may take the form of a quantum computing storage device for storing data in the form of qubits. In embodiments where computer 102 is required to have a large amount of storage (for example, where computer 102 locally stores and manages a large database), this storage may be provided by peripheral storage devices designed for storing very large amounts of data, such as a storage area network (SAN) that is shared by multiple, geographically distributed computers. IoT sensor set 136 is made up of sensors that can be used in Internet of Things applications. For example, one sensor may be a thermometer and another sensor may be a motion detector.

Network module 124 is the collection of computer software, hardware, and firmware that allows computer 102 to communicate with other computers through WAN 104. Network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 124 are performed on the same physical hardware device. In other embodiments (for example, embodiments that utilize software-defined networking (SDN)), the control functions and the forwarding functions of network module 124 are performed on physically separate devices, such that the control functions manage several different network hardware devices. Computer-readable program instructions for performing the inventive methods can typically be downloaded to computer 102 from an external computer or external storage device through a network adapter card or network interface included in network module 124.

WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and/or edge servers.

EUD 106 is any computer system that is used and controlled by an end user (for example, a customer of an enterprise that operates computer 102), and may take any of the forms discussed above in connection with computer 102. EUD 106 typically receives helpful and useful data from the operations of computer 102. For example, in a hypothetical case where computer 102 is designed to provide a recommendation to an end user, this recommendation would typically be communicated from network module 124 of computer 102 through WAN 104 to EUD 106. In this way, EUD 106 can display, or otherwise present, the recommendation to an end user. In some embodiments, EUD 106 may be a client device, such as thin client, heavy client, mainframe computer, desktop computer and so on.

Remote server 108 is any computer system that serves at least some data and/or functionality to computer 102. Remote server 108 may be controlled and used by the same entity that operates computer 102. Remote server 108 represents the machine(s) that collect and store helpful and useful data for use by other computers, such as computer 102. For example, in a hypothetical case where computer 102 is designed and programmed to provide a recommendation based on historical data, this historical data may be provided to computer 102 from remote database 138 of remote server 108.

Public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 110 is performed by the computer hardware and/or software of cloud orchestration module 142. The computing resources provided by public cloud 110 are typically implemented by virtual computing environments that run on various computers making up the computers of host physical machine set 144, which is the universe of physical computers in and/or available to public cloud 110. The virtual computing environments (VCEs) typically take the form of virtual machines from virtual machine set 146 and/or containers from container set 148. These VCEs may be stored as images and may be transferred among and between the various physical machine hosts, either as images or after instantiation of the VCE. Cloud orchestration module 142 manages the transfer and storage of images, deploys new instantiations of VCEs, and manages active instantiations of VCE deployments. Gateway 140 is the collection of computer software, hardware, and firmware that allows public cloud 110 to communicate through WAN 104.

Some further explanation of VCEs will now be provided. VCEs can be stored as “images.” A new active instance of a VCE can be instantiated from the image. Two familiar types of VCEs are virtual machines and containers. A container is a VCE that uses operating-system-level virtualization, which refers to an operating system feature in which the kernel allows the existence of multiple isolated user-space instances, or containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 112 is similar to public cloud 110, except that the computing resources are only available for use by a single enterprise. While private cloud 112 is depicted as being in communication with WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this example, public cloud 110 and private cloud 112 are both part of a larger hybrid cloud.

Cloud computing services and/or microservices (not separately shown in FIG. 1): private and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where content is being presented to an internal or external customer in the form of a cloud computing service. As-a-service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with such tasks. Another category is Software-as-a-Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some implementations, a device (e.g., computer 102, computer system) may perform operations. The operations may include: receive a satellite observation and a geo-spatial model of a forest or agricultural ecosystem; estimate, based on the satellite observation and the geo-spatial model, a forecasted spatiotemporal distribution of aerosol concentration and a corresponding aerosol impact on photosynthesis activity in the forest or agricultural ecosystem; determine, from the satellite observation, a dust profile and a corresponding dust impact on the photosynthesis activity based on spectral reflectance from leaves in the forest or agricultural ecosystem; estimate an amount of cloud seeding or an amount of aerosol ionization to maintain an optimal aerosol optical depth in an atmosphere above the forest or agricultural system; determine an optimal set of locations for the cloud seeding or the aerosol ionization based on a cost-benefit analysis; and output the optimal set of locations.

In some implementations, the operations may include: receive a satellite observation and a geo-spatial model associated with a forecasted spatiotemporal distribution of aerosol concentration and an impact on photosynthesis activity in a forest or an agricultural ecosystem; determine a forecasted dust profile on leaves and a corresponding impact on the photosynthesis activity of the forest or the agricultural ecosystem using spectral reflectance from the leaves; and output, based on a cost-benefit analysis, an indication of whether to perform cloud seeding or aerosol ionization to maintain an optimal aerosol optical depth in an atmosphere above the forest or the agricultural ecosystems.

In some implementations, the operations may include: evaluate, a satellite observation and a geo-spatial model, a forecasted spatiotemporal distribution of aerosol concentration above a forest or agricultural ecosystem and a corresponding impact on photosynthesis activity in the forest or agricultural ecosystem; estimate an amount of cloud seeding or an amount of aerosol ionization to maintain an optimal aerosol optical depth in an atmosphere above the forest or agricultural ecosystem based on a volumetric analysis; and output an indication to deploy cloud seeding or aerosol ionization to maximize the photosynthesis activity or carbon sequestration based on a cost-benefit analysis.

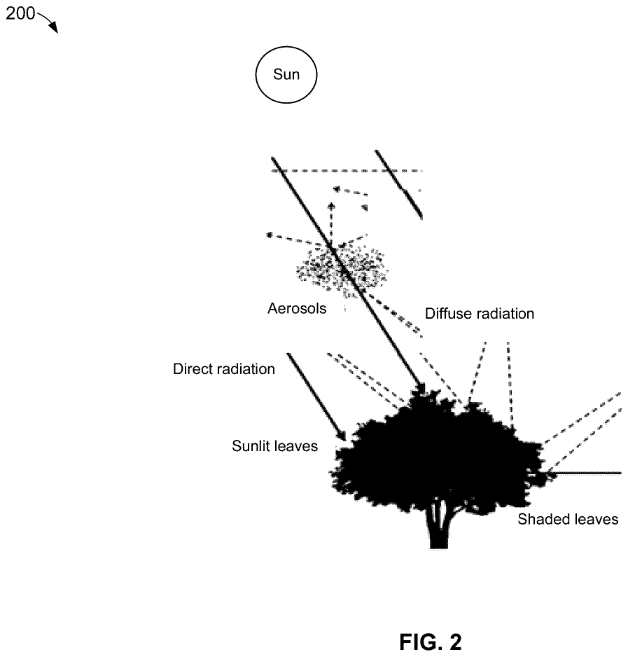

FIG. 2 illustrates an example 200 of direct and diffuse sunlight that radiates on the Earth's surface and aerosols that can affect this radiation. “Direct radiation” refers to direct sunlight that reaches the leaves of plants on the Earth's surface, while diffused radiation is the scattered sunlight that is dispersed in all directions by the atmosphere and other objects. Both types of radiation play a crucial role in photosynthesis, the process by which plants convert sunlight into energy. Photosynthesis sequesters carbon dioxide in the atmosphere.

Aerosols, which are tiny particles suspended in the atmosphere, can impact the balance between direct and diffused radiation. The aerosol particles can scatter or absorb radiation, affecting the amount of direct and diffused radiation that reaches the leaves. This, in turn, can impact photosynthesis and plant growth.

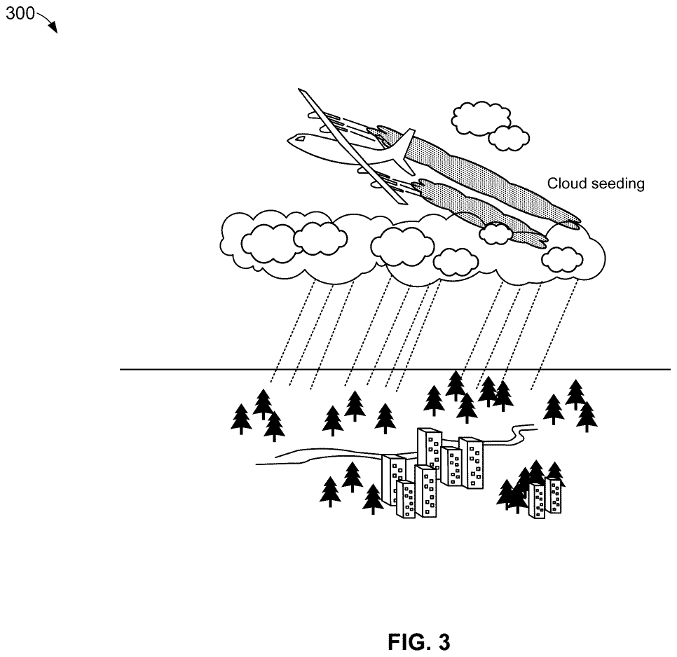

FIG. 3 is a diagram of an example 300 of cloud seeding. Cloud seeding is a form of weather modification that involves introducing substances into clouds to enhance precipitation, usually to induce rain or snow. The goal of cloud seeding is to stimulate the natural process of precipitation formation by providing additional nucleating agents that facilitate the growth of ice crystals or water droplets within clouds. There are several types of materials used for cloud seeding, depending on the type of cloud, the desired outcome, and the specific weather conditions. Silver iodide is the most commonly used material for cloud seeding. Silver iodide is a crystal-forming substance that can be introduced into clouds through aircraft-mounted generators or ground-based delivery systems. Silver iodide helps to form ice crystals, which can then grow into larger ice crystals and eventually become too heavy to remain suspended in the air, resulting in precipitation. Other materials may include carbamide, hygroscopic materials, such as sodium chloride or calcium chloride, or other salts.

FIG. 4A is a diagram of an example implementation 400 associated with controlling aerosol in the atmosphere. A computer system (e.g., computer 102) may perform the operations of example implementation 400. FIG. 4B illustrates components of the computer system, such as the aerosol control code 150 of FIG. 1 that may perform operations of a computer-implemented method shown in FIG. 4A. The aerosol control code 150 may include a cloud seeding module 440, an aerosol ionization module 442, an estimation module 444, a cost-benefit analysis module 446, and an output module 448. Each module of the aerosol control code 150 may operate using the processor set 114, communication fabric 116, volatile memory 118, and persistent storage 120 of computer 102 illustrated in FIG. 1.

In FIG. 4A, example implementation 400 shows that the computer system may receive (e.g., using estimation module 444) geolocation information, geo-spatial foundation models, and information about terrain topography, a weather profile, atmospheric conditions, a dust characteristics profile, a cloud seeding system, and a power rating.

Implementation 400 shows that the computer system may accelerate natural carbon sequestration through photosynthesis by optimizing the amount of cloud seeding or aerosol ionization in the atmosphere to control the concentration of aerosols, dust particles, and other environmental conditions that impact photosynthesis. The computer system may perform computer simulations to estimate the impact of different levels of aerosol and dust particles on photosynthesis, and to determine the optimal amount of cloud seeding or aerosol ionization needed to maintain an optimal level of aerosol concentrations in the atmosphere. The computer simulations may combine data from satellite observations, geo-spatial foundation models, and information about geolocation, terrain topography, weather profile, and atmospheric conditions to estimate the effects of aerosol and dust particles on photosynthesis. The computer system may use optimization techniques, such as volumetric analysis, to determine the cost of different cloud seeding and ionization options, as well as the cost-benefit trade-off between reducing carbon emissions and increasing photosynthesis. “Volumetric analysis” refers to a method of analysis that involves measuring the volume of a substance or object, typically in a three-dimensional space. In the context of aerosol particles, volumetric analysis can be used to quantify the amount of particles present in a given volume of air. Volumetric analysis may include physical volumetry (e.g., a measure of the physical volume of a substance or object), chemical volumetry (a measure of the chemical properties of a substance or object), or computational volumetry (e.g., using computational models and simulations to analyze the volume of a substance or object). The volumetric analysis may be used to obtain an aerosol concentration, a particle size distribution, cloud formation and precipitation parameters, or an air quality. By applying volumetric analysis techniques, the computer system may model the behavior of aerosol particles.

The computer system may collect various information for estimation (e.g., using the estimation module 444). As shown by 414, the computer system may estimate the distribution of sunlit and shaded leaves. This may involve collecting geolocation information and satellite observations (e.g., multispectral, hyperspectral optimal, and microwave), shown at 402. The computer system may also use information about terrain topography, a weather profile (e.g., humidity, wind temperature, precipitation), and atmospheric conditions (e.g., pressure), shown at 404, to estimate a required amount of cloud seeding or aerosol ionization, shown at 416. The computer may use volumetric analysis. The computer system may also use this information to obtain, develop, or fine-tune geo-spatial foundation models, shown at 410, which is used to estimate the forecasted atmospheric particle matter distribution and optical depth, at 412. In some implementations, estimating the forecasted atmospheric particle matter distribution and optical depth may include leveraging geo-spatial foundation models to estimate the aerosol distribution and optical depth. For example, the geo-spatial foundation models may take into account the terrain topography, weather profile, and atmospheric conditions to provide a detailed estimate of the aerosol distribution and optical depth. The computer system may use the geo-spatial foundation models to estimate the terrain topography and adjust the amount of cloud seeding or aerosol ionization accordingly.

The computer system may estimate the required amount of cloud seeding or aerosol ionization further based on a dust characteristics profile, shown at 420, which may include an optimal AOD for a given weather profile. The computer system may estimate the required amount of cloud seeding or aerosol ionization further based on the cloud seeding system, which may use a type of seeding (e.g., potassium iodide, silver iodide, dry ice, salt crystals, etc.), shown at 422. This information may be determined and provided by cloud seeding module 440.

The computer system, at 418 using the cost-benefit analysis module 446, may estimate the cost of the cloud seeding based on the cloud seeding system information of 422. The computer system may also estimate the cost of the aerosol ionization based on information about the deployment of the aerosol ionization, such as the voltage level and/or the power rating of the ionization, shown at 424. This information may be determined and provided by the aerosol ionization module 442. For example, the computer system may use a higher voltage level or power rating for aerosol ionization in areas with high levels of aerosol concentration.

The computer system (e.g., computer 102) may estimate (e.g., using the estimation module 444) the impact of a dust type and distribution on the leaves, at 406, and the corresponding impact of the AOD on the photosynthetic activity of sunlit and shaded leaves, at 408. The computer system then estimates the distribution of sunlit and shaded leaves and AOD overall impact on photosynthetic activity of sunlit and shaded leaves, at 414. This estimate may be based on geo-spatial foundation models, at 410, and the forecasted atmospheric particle matter distribution and AOD, at 412. In some implementations, estimating the impact of aerosol optical depth on photosynthetic activity may include considering the two forms of radiation, direct and diffuse radiation. For example, the computer system may estimate the impact of AOD on photosynthetic activity by taking into account the proportion of sunlit and shaded leaves and the impact of AOD on both types of radiation. The estimate of the distribution and impact may also be based on a forest and plant knowledge base 426, which may involve the type of dust, the dust vs. photosynthesis rate, the AOD vs. sun and shaded photosynthesis rate, and the weather (e.g., humidity, wind, temperature).

Additionally, or alternatively, estimating the aerosol distribution and its AOD in the atmosphere may include using a machine learning model. For example, the computer system may use a machine learning model to estimate the aerosol distribution and its AOD in the atmosphere, which can be trained on historical data and fine-tuned to improve its accuracy.

The computer system may, at 428, use this estimate of the distribution and impact of 414 with the estimate of the impact on the photosynthesis rate due to the dust distribution of 408 to perform a cost-benefit analysis (e.g., using the cost-benefit analysis module 446) of the carbon sequestration benefit vs. the cost of cloud seeding or aerosol ionization. The computer system may use an estimate of the cost incurred for cloud seeding or aerosol ionization, at 418, as part of the cost-benefit analysis. In some implementations, the computer system may estimate the cost of cloud seeding using literature, historical data, and business use cases to determine the most cost-effective method for achieving optimal aerosol levels. The cost-benefit analysis may involve evaluating the trade-off between the gain in photosynthesis activity or carbon sequestration and the cost incurred in deploying the cloud seeding or aerosol ionization. The computer system may consider factors that may indicate a positive value, as compared to the costs. The computer system may determine whether the positive value meets or exceeds the costs, in order to provide a recommendation.

Finally, the computer system may determine, at 430, whether to deploy cloud seeding or ionization (428) based at least in part on the cost-benefit analysis at 428. The computer system may also determine the amount and/or a set of one or more locations for the cloud seeding or aerosol ionization. The computer system may generate information for cloud seeding (e.g., using the cloud seeding module 440) or for aerosol ionization (e.g., using the aerosol ionization module 442). The computer system may then output this information (e.g., using output module 448). The computer system may transmit this information to entities that deploy cloud seeding or aerosol ionization, or provide this information on a display of the computer system.

FIG. 5 is an example 500 of a spatial map. The map may include features such as hotspots (areas with exceptionally high carbon sequestration potential, marked with symbols or colors), or boundaries of forests, agricultural ecosystems, or other areas of interest. The spatial map may provide a visual representation of the areas with available additional gain in photosynthesis activity or carbon sequestration.

Given an n×n grid of identified aerosol concentrations, the optimal set of “j” may be selected such that the photosynthesis activity can be enhanced for higher carbon sequestration for the forecasted horizon “t” by clearing the aerosol through cloud seeding to the optimal intermediate level of AOD, cleaning the dust on the leaves, and minimizing the overall cost of deploying cloud seeding. The computer system may use a cost function J=MaxΣ_(j=1, t)\hat{ }N [symbol] }, where w_{AOD}×E_{AOD, j, t} represents the additional gain in photosynthesis activity or carbon sequestration by setting AOD to an optimal value at pixel j for time t, w_{dust}×E_{dust, j, t} represents the additional gain in photosynthesis activity or carbon sequestration from clearing the dust at pixel j for time t. These are positive impacts. u_{j, t}×w_{Dc}×C_{j, t} represents the cost of cloud seeding, and v_{j, t}×w_{DI}×I_{j, t} represents the cost of aerosol ionization, which may be negative impacts.

The different elements may include ujfor a binary decision variable (optimal identified hotspot pixel j), E_{AOD, j, t} for the cost of additional gain in photosynthesis activity or carbon sequestration after clearing the aerosol at pixel j for time t, E_{dust, j, t} for the cost of additional gain in photosynthesis activity or carbon sequestration after cleaning the dust in the leaves at pixel j for time t. Cjfor the cost of cloud seeding at pixel j, and I jis for the cost of an aerial-based ionization process at pixel j. w_{AOD}, w_{dust}, w_{Dc}, w_{DI} may be weighted coefficients associated with additional photosynthetic activity. w_{AOD} is for clearing aerosol in the atmosphere, w_{dust} is for cleaning the dust on the leaves, w_{Dc} is for the expense for cloud seeding, and w_{DI} ionization process respectively.

In some aspects, the computer system may generate the spatial map by estimating the proportion of sun leaves and shaded leaves in a given location. For example, the system may use satellite images and machine learning models to analyze the forest canopy structure and density, which can be used to determine the optimal value of aerosol optical depth for the given environmental condition.

Additionally, or alternatively, the computer system may use the spatial map to determine the optimal value of AOD for a given environmental condition, considering the combined effect on sun leaves and shaded leaves. For example, the system may use the estimated proportion of sun leaves and shaded leaves to determine the optimal value of AOD.

FIG. 6 is a flowchart of an example process 600 associated with atmospheric aerosol control. One or more process blocks of FIG. 6 are performed by a computer system (e.g., computer 102) and/or by another device or a group of devices separate from or including the computer system.

As shown in FIG. 6, process 600 includes receiving a satellite observation and a geo-spatial model of a forest or agricultural ecosystem (block 610). For example, the computer system may receive a satellite observation and a geo-spatial model of a forest or agricultural ecosystem as described above.

As further shown in FIG. 6, process 600 includes estimating, based on the satellite observation and the geo-spatial model, a forecasted spatiotemporal distribution of aerosol concentration and a corresponding aerosol impact on photosynthesis activity in the forest or agricultural ecosystem (block 620). For example, the computer system may estimate, based on the satellite observation and the geo-spatial model, a forecasted spatiotemporal distribution of aerosol concentration and a corresponding aerosol impact on photosynthesis activity in the forest or agricultural ecosystem as described above.

As further shown in FIG. 6, process 600 includes determining, from the satellite observation, a dust profile and a corresponding dust impact on the photosynthesis activity based on spectral reflectance from leaves in the forest or agricultural ecosystem (block 630). For example, the computer system may determine, from the satellite observation, a dust profile and a corresponding dust impact on the photosynthesis activity based on spectral reflectance from leaves in the forest or agricultural ecosystem as described above.

As further shown in FIG. 6, process 600 includes estimating an amount of cloud seeding or an amount of aerosol ionization to maintain an optimal AOD in an atmosphere above the forest or agricultural system (block 640). For example, the computer system may estimate an amount of cloud seeding or an amount of aerosol ionization to maintain an optimal AOD in an atmosphere above the forest or agricultural system as described above.

As further shown in FIG. 6, process 600 includes determining an optimal set of locations for the cloud seeding or the aerosol ionization based on a cost-benefit analysis (block 650). For example, the computer system may determine an optimal set of locations for the cloud seeding or the aerosol ionization based on a cost-benefit analysis as described above.

As further shown in FIG. 6, process 600 includes outputting the optimal set of locations (block 660). For example, the computer system may output the optimal set of locations as described above.

Process 600 may include additional aspects, such as any single aspect or any combination of aspects described below and/or in connection with one or more other processes described elsewhere herein.

In a first aspect, the cost-benefit analysis comprises evaluating a trade-off between a gain in the photosynthesis activity or carbon sequestration and a cost incurred in deploying the cloud seeding or the aerosol ionization, estimating a cost of additional photosynthesis activity or carbon sequestration after clearing aerosol and dust in the leaves, and estimating a cost of the cloud seeding and the aerosol ionization.

In a second aspect, alone or in combination with the first aspect, the estimating of the forecasted spatiotemporal distribution of aerosol concentration and its aerosol impact on the photosynthesis activity comprises estimating a distribution of sun and shaded leaves in the forest or agricultural ecosystem, estimating a positive impact or a negative impact of an aerosol concentration on photosynthesis activity of sun and shaded leaves, and determining the optimal aerosol optical depth for maximizing the photosynthesis activity based on the distribution of sun and shaded leaves and the positive impact or the negative impact.

In a third aspect, alone or in combination with one or more of the first and second aspects, the estimating of the distribution of sun and shaded leaves comprises estimating the distribution of sun and shaded leave using the satellite observation and the geo-spatial model.

In a fourth aspect, alone or in combination with one or more of the first through third aspects, process 600 includes determining the spectral reflectance from the leaves by identifying a type and a distribution of dust particles on the leaves, estimating an impact of the dust particles on photosynthesis activity based on the type and the distribution of the dust particles on the leaves, determining a requirement for dust cleaning based on the estimated impact, and selecting a dust cleaning method based on the requirement.

In a fifth aspect, alone or in combination with one or more of the first through fourth aspects, the identifying of the type and the distribution of dust particles on the leaves comprises using spectral reflectance from leaves to estimate the type and the distribution of dust particles on the leaves.

In a sixth aspect, alone or in combination with one or more of the first through fifth aspects, the estimating of the amount of cloud seeding comprises estimating of the amount of cloud seeding based on the amount of aerosol ionization, or the estimating of the amount of aerosol ionization comprises estimating the amount of aerosol ionization based on the amount of the cloud seeding.

In a seventh aspect, alone or in combination with one or more of the first through sixth aspects, the estimating of the amount of cloud seeding or the amount of aerosol ionization comprises estimating of the amount of cloud seeding or the amount of aerosol ionization further based on a terrain topography of the forest or agricultural ecosystem, a weather profile for the forest or agricultural ecosystem, atmospheric conditions above the forest or agricultural ecosystem, and one or more parameters for the cloud seeding or the aerosol ionization.

In an eighth aspect, alone or in combination with one or more of the first through seventh aspects, the estimating of the amount of the cloud seeding or the amount of the aerosol ionization comprises estimating the amount of the cloud seeding or the amount of the aerosol ionization using volumetric analysis.

In a ninth aspect, alone or in combination with one or more of the first through eighth aspects, process 600 includes outputting a recommendation for optimal cloud seeding or aerosol ionization based on integrating with existing agricultural or forestry systems.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

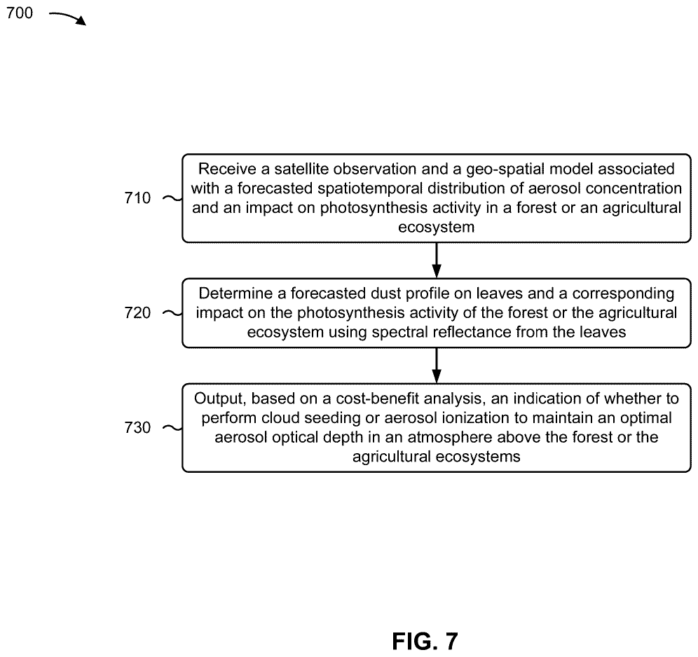

FIG. 7 is a flowchart of an example process 700 associated with atmospheric aerosol control. One or more process blocks of FIG. 7 are performed by a computer system (e.g., computer 102) and/or by another device or a group of devices separate from or including the computer system.

As shown in FIG. 7, process 700 includes receiving a satellite observation and a geo-spatial model associated with a forecasted spatiotemporal distribution of aerosol concentration and an impact on photosynthesis activity in a forest or an agricultural ecosystem (block 710). For example, the computer system may receive a satellite observation and a geo-spatial model associated with a forecasted spatiotemporal distribution of aerosol concentration and an impact on photosynthesis activity in a forest or an agricultural ecosystem as described above.

As further shown in FIG. 7, process 700 includes determining a forecasted dust profile on leaves and a corresponding impact on the photosynthesis activity of the forest or the agricultural ecosystem using spectral reflectance from the leaves (block 720). For example, the computer system may determine a forecasted dust profile on leaves and a corresponding impact on the photosynthesis activity of the forest or the agricultural ecosystem using spectral reflectance from the leaves as described above.

As further shown in FIG. 7, process 700 includes outputting, based on a cost-benefit analysis, an indication of whether to perform cloud seeding or aerosol ionization to maintain an optimal aerosol optical depth in an atmosphere above the forest or the agricultural ecosystems (block 730). For example, the computer system may output, based on a cost-benefit analysis, an indication of whether to perform cloud seeding or aerosol ionization to maintain an optimal aerosol optical depth in an atmosphere above the forest or the agricultural ecosystems as described above.

Process 700 may include additional aspects, such as any single aspect or any combination of aspects described below and/or in connection with one or more other processes described elsewhere herein.

In a first aspect, the cost-benefit analysis comprises evaluating a trade-off between a gain in the photosynthesis activity or carbon sequestration and a cost incurred in deploying the cloud seeding or the aerosol ionization, estimating a cost of additional photosynthesis activity or carbon sequestration after clearing aerosol and dust in the leaves, and estimating a cost of the cloud seeding and the aerosol ionization.

In a second aspect, alone or in combination with the first aspect, the operations comprise estimating an amount of the cloud seeding or the aerosol ionization using a volumetric analysis.

In a third aspect, alone or in combination with one or more of the first and second aspects, the operations comprise leveraging geo-spatial foundation models to estimate the aerosol distribution and the optical depth in the atmosphere.

In a fourth aspect, alone or in combination with one or more of the first through third aspects, the operations comprise determining an optimal value of AOD for a given environmental condition to accelerate natural carbon sequestration.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

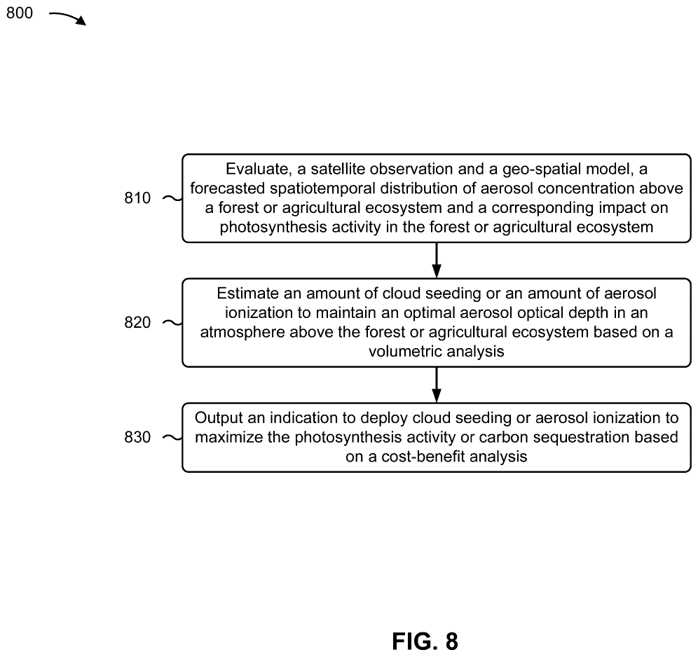

FIG. 8 is a flowchart of an example process 800 associated with atmospheric aerosol control. One or more process blocks of FIG. 8 are performed by a computer system (e.g., computer 102) and/or by another device or a group of devices separate from or including the computer system.

As shown in FIG. 8, process 800 includes evaluating, a satellite observation and a geo-spatial model, a forecasted spatiotemporal distribution of aerosol concentration above a forest or agricultural ecosystem and a corresponding impact on photosynthesis activity in the forest or agricultural ecosystem (block 810). For example, the computer system may evaluate, a satellite observation and a geo-spatial model, a forecasted spatiotemporal distribution of aerosol concentration above a forest or agricultural ecosystem and a corresponding impact on photosynthesis activity in the forest or agricultural ecosystem as described above.

As further shown in FIG. 8, process 800 includes estimating an amount of cloud seeding or an amount of aerosol ionization to maintain an optimal aerosol optical depth in an atmosphere above the forest or agricultural ecosystem based on a volumetric analysis (block 820). For example, the computer system may estimate an amount of cloud seeding or an amount of aerosol ionization to maintain an optimal aerosol optical depth in an atmosphere above the forest or agricultural ecosystem based on a volumetric analysis as described above.

As further shown in FIG. 8, process 800 includes outputting an indication to deploy cloud seeding or aerosol ionization to maximize the photosynthesis activity or carbon sequestration based on a cost-benefit analysis (block 830). For example, the computer system may output an indication to deploy cloud seeding or aerosol ionization to maximize the photosynthesis activity or carbon sequestration based on a cost-benefit analysis as described above. In some embodiments, this may cause automatic deployment of cloud seeding or aerosol ionization devices.

Process 800 may include additional aspects, such as any single aspect or any combination of aspects described below and/or in connection with one or more other processes described elsewhere herein.

In a first aspect, the operations further comprise analyzing spectral reflectance from leaves of the forest or agricultural ecosystem to determine a dust profile and a corresponding impact on the photosynthesis activity, and estimating an additional gain in the photosynthesis activity or the carbon sequestration from cleaning a dust settlement on the leaves through cloud seeding.

In a second aspect, alone or in combination with the first aspect, the cost-benefit analysis comprises evaluating a trade-off between an additional gain in the photosynthesis activity or the carbon sequestration, and estimating a cost incurred in deploying cloud seeding or aerosol ionization.

In a third aspect, alone or in combination with one or more of the first and second aspects, the optimal aerosol optical depth is based on a weather profile for the forest or agricultural ecosystem.

In a fourth aspect, alone or in combination with one or more of the first through third aspects, the estimating of the amount of aerosol ionization comprises estimating the amount of aerosol ionization further based on a voltage level or a power rating of the aerosol ionization.

Although FIG. 8 shows example blocks of process 800, in some implementations, process 800 includes additional blocks, fewer blocks, different blocks, or differently arranged blocks than those depicted in FIG. 8. Additionally, or alternatively, two or more of the blocks of process 800 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving a satellite observation and a geo-spatial model of a forest or agricultural ecosystem;
estimating, based on the satellite observation and the geo-spatial model, a forecasted spatiotemporal distribution of aerosol concentration and a corresponding aerosol impact on photosynthesis activity in the forest or agricultural ecosystem;
determining, from the satellite observation, a dust profile and a corresponding dust impact on the photosynthesis activity based on spectral reflectance from leaves in the forest or agricultural ecosystem;
estimating an amount of cloud seeding or an amount of aerosol ionization to maintain an optimal aerosol optical depth in an atmosphere above the forest or agricultural ecosystem;
determining an optimal set of locations for the cloud seeding or the aerosol ionization based on a cost-benefit analysis; and
outputting the optimal set of locations.

2. The method of claim 1, wherein the cost-benefit analysis comprises:
evaluating a trade-off between a gain in the photosynthesis activity or carbon sequestration and a cost incurred in deploying the cloud seeding or the aerosol ionization;
estimating a cost of additional photosynthesis activity or carbon sequestration after clearing aerosol and dust in the leaves; and
estimating a cost of the cloud seeding and the aerosol ionization.

3. The method of claim 1, wherein the estimating of the forecasted spatiotemporal distribution of aerosol concentration and its aerosol impact on the photosynthesis activity comprises:
estimating a distribution of sun and shaded leaves in the forest or agricultural ecosystem;
estimating a positive impact or a negative impact of an aerosol concentration on photosynthesis activity of sun and shaded leaves; and
determining the optimal aerosol optical depth for maximizing the photosynthesis activity based on the distribution of sun and shaded leaves and the positive impact or the negative impact.

4. The method of claim 3, wherein the estimating of the distribution of sun and shaded leaves comprises estimating the distribution of sun and shaded leave using the satellite observation and the geo-spatial model.

5. The method of claim 1, further comprising determining the spectral reflectance from the leaves by:
identifying a type and a distribution of dust particles on the leaves;
estimating an impact of the dust particles on photosynthesis activity based on the type and the distribution of the dust particles on the leaves;
determining a requirement for dust cleaning based on the estimated impact; and
selecting a dust cleaning method based on the requirement.

6. The method of claim 5, wherein the identifying of the type and the distribution of dust particles on the leaves comprises:
using spectral reflectance from leaves to estimate the type and the distribution of dust particles on the leaves.

7. The method of claim 1, wherein the estimating of the amount of cloud seeding comprises the estimating of the amount of cloud seeding based on the amount of aerosol ionization, or wherein the estimating of the amount of aerosol ionization comprises estimating the amount of aerosol ionization based on the amount of the cloud seeding.

8. The method of claim 1, wherein the estimating of the amount of cloud seeding or the amount of aerosol ionization comprises the estimating of the amount of cloud seeding or the amount of aerosol ionization further based on a terrain topography of the forest or agricultural ecosystem, a weather profile for the forest or agricultural ecosystem, atmospheric conditions above the forest or agricultural ecosystem, and one or more parameters for the cloud seeding or the aerosol ionization.

9. The method of claim 1, wherein the estimating of the amount of the cloud seeding or the amount of the aerosol ionization comprises:
estimating the amount of the cloud seeding or the amount of the aerosol ionization using volumetric analysis.

10. The method of claim 1, further comprising:
outputting a recommendation for optimal cloud seeding or aerosol ionization based on integrating with existing agricultural or forestry systems.

11. A computer system comprising:
a processor set;
one or more computer-readable storage media; and
program instructions stored on the one or more computer-readable storage media to cause the processor set to perform operations comprising:
receiving a satellite observation and a geo-spatial model associated with a forecasted spatiotemporal distribution of aerosol concentration and an impact on photosynthesis activity in a forest or an agricultural ecosystem;
determining a forecasted dust profile on leaves and a corresponding impact on the photosynthesis activity of the forest or the agricultural ecosystem using spectral reflectance from the leaves; and
outputting, based on a cost-benefit analysis, an indication of whether to perform cloud seeding or aerosol ionization to maintain an optimal aerosol optical depth in an atmosphere above the forest or the agricultural ecosystems.

12. The computer system of claim 11, wherein the cost-benefit analysis comprises:
evaluating a trade-off between a gain in the photosynthesis activity or carbon sequestration and a cost incurred in deploying the cloud seeding or the aerosol ionization;
estimating a cost of additional photosynthesis activity or carbon sequestration after clearing aerosol and dust in the leaves; and
estimating a cost of the cloud seeding and the aerosol ionization.

13. The computer system of claim 11, wherein the operations comprise:
estimating an amount of the cloud seeding or the aerosol ionization using a volumetric analysis.

14. The computer system of claim 11, wherein the operations comprise:
leveraging geo-spatial foundation models to estimate an aerosol distribution and optical depth in the atmosphere.

15. The computer system of claim 11, wherein the operations comprise determining an optimal value of aerosol optical depth for a given environmental condition to accelerate natural carbon sequestration.

16. A computer program product comprising:
one or more computer-readable storage media;
program instructions stored on the one or more computer-readable storage media to perform operations comprising:
evaluating, a satellite observation and a geo-spatial model, a forecasted spatiotemporal distribution of aerosol concentration above a forest or agricultural ecosystem and a corresponding impact on photosynthesis activity in the forest or agricultural ecosystem;
estimating an amount of cloud seeding or an amount of aerosol ionization to maintain an optimal aerosol optical depth in an atmosphere above the forest or agricultural ecosystem based on a volumetric analysis; and
outputting an indication to deploy cloud seeding or aerosol ionization to maximize the photosynthesis activity or carbon sequestration based on a cost-benefit analysis.

17. The computer program product of claim 16, wherein the operations further comprise:
analyzing spectral reflectance from leaves of the forest or agricultural ecosystem to determine a dust profile and a corresponding impact on the photosynthesis activity; and
estimating an additional gain in the photosynthesis activity or the carbon sequestration from cleaning a dust settlement on the leaves through cloud seeding.

18. The computer program product of claim 16, wherein the cost-benefit analysis comprises:
evaluating a trade-off between an additional gain in the photosynthesis activity or the carbon sequestration; and
estimating a cost incurred in deploying cloud seeding or aerosol ionization.

19. The computer program product of claim 16, wherein the optimal aerosol optical depth is based on a weather profile for the forest or agricultural ecosystem.

20. The computer program product of claim 16, wherein the estimating of the amount of aerosol ionization comprises estimating the amount of aerosol ionization further based on a voltage level or a power rating of the aerosol ionization.
